(19) United States
(12) Patent Application Publication
(10) Pub. No.: US 2008/0228988 A1
(43) Pub. Date: Sep. 18, 2008

(54) METHOD FOR TRANSMITTING CONFIGURATION DATA VIA A CONFIGURATION DATA BUS IN A MEMORY ARRANGEMENT, CONFIGURATION DATA BUS STRUCTURE, MEMORY ARRANGEMENT, AND COMPUTER SYSTEM

(75) Inventors: Paul Wallner, Prien (DE); Roland Ernst, Pliening (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Qimonda AG, Munchen (DE)

(21) Appl. No.: 11/686,700

(22) Filed: Mar. 15, 2007

(51) Int. Cl. G06F 13/00

(52) U.S. Cl. 711/100

(57) ABSTRACT

A method transmits configuration data in a memory arrangement. The method includes controlling, with a control unit of the memory arrangement, data transmissions via a configuration data bus in the memory arrangement, the controlling including controlling transmitting configuration data of the memory arrangement for storing in at least two register units of the memory arrangement via the configuration data bus from the control unit to each of the at least two register units. The method includes storing, in the at least two register units, the configuration data. The at least two register units have a same bus address identifying the at least two register units on the configuration data bus. The method includes requesting, with the control unit, configuration data stored in the at least two register units. The method includes transmitting, under control of the control unit, the stored configuration data via the configuration data bus from only one of the at least two register units to the control unit.

### BACKGROUND

Electronic data processing systems, such as computer systems typically include one or more memory arrangements for storing data. An example memory arrangement includes one or more data busses adapted to transmit data.

### SUMMARY

One embodiment provides a method of transmitting configuration data in a memory arrangement. The method includes controlling, with a control unit of the memory arrangement, data transmissions via a configuration data bus in the memory arrangement, the controlling including controlling transmitting configuration data of the memory arrangement for storing in at least two register units of the memory arrangement via the configuration data bus from the control unit to each of the at least two register units. The method includes storing, in the at least two register units, the configuration data. The at least two register units have a same bus address identifying the at least two register units on the configuration data bus. The method includes requesting, with the control unit, configuration data stored in the at least two register units. The method includes transmitting, under control of the control unit, the stored configuration data via the configuration data bus from only one of the at least two register units to the control unit.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic view of a memory arrangement according to an embodiment connected with a memory arrangement configuration device.

FIG. 2 is a schematic view of a computer system according to an embodiment.

FIG. 3 is a schematic view of a configuration data bus structure according to an embodiment.

FIG. 4 is a schematic view of a configuration data bus structure according to an embodiment comprising two control units.

FIG. 5 is a schematic view of a configuration data bus structure according to an embodiment comprising an access control unit.

FIG. 6 is a schematic view of a configuration data bus structure according to an embodiment comprising two control units and an access control unit.

FIG. 7 is a diagram representing the data flow on a configuration data bus structure according to an embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

It is also to be understood that, in the following detailed description of the exemplary embodiments, any direct connection or coupling between functional blocks, devices, components, or other physical or functional units illustrated in the drawings or described herein could also be implemented by an indirect connection or coupling.

It is further to the understood that the features of various exemplary embodiments described herein may be combined with each other, unless specifically noted otherwise.

The present invention generally relates to the field of memory arrangements and, in particular, to memory arrangements used in data processing devices, for example in computer systems. Particularly, the present invention relates to memory arrangements comprising configurable settings adapting the memory arrangement to specific parameters of the environment the memory arrangement is used in. These settings or configuration data may comprise for example timing parameters, address mappings, address offsets, address ranges, the use of error detecting and correcting means, or protocol characteristics of a protocol used between the memory arrangement and the data processing unit. Moreover, this may comprise also special settings for test and analysis of the memory arrangement.

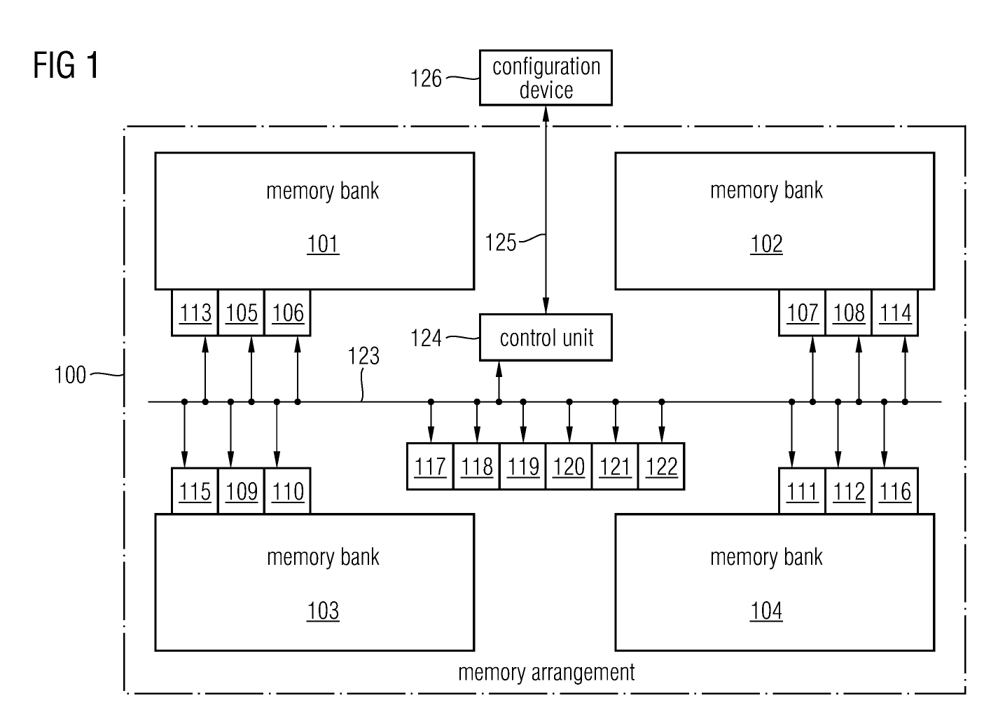

FIG. 1 illustrates an embodiment of a memory arrangement 100. The memory arrangement 100 may comprise four data banks 101-104 comprising memory cells for storing and providing data which may be processed by a data processing unit in a computer system. The memory arrangement 100 comprises further configuration data register units 105-122. Several types of configuration data stored in the register units 105-122 may be distinguished:

A example first type of configuration data relates to the memory arrangement 100 as a whole and is used by the memory arrangement 100 within one specific circuit part only. Configuration data like this may comprise for example timing and protocol characteristics of an interface between the memory arrangement 100 and the data processing unit the memory arrangement is connected to. Register units for storing this type of configuration data are for example register units 117-122 in FIG. 1.

An example second type of configuration data may comprise configuration data which is configurable independently for each of the data banks 101-104. This may comprise for example address mapping or address offset configurations for the memory banks 101-104. To achieve short connections between these register units and the corresponding memory banks the configuration data register units containing these configuration data are placed in the embodiment illustrated in FIG. 1 near each of the memory banks 101-104. As illustrated in FIG. 1, this kind of register units may comprise the register units 105, 106 for memory bank 101, register units 107, 108 for memory bank 102, register units 109, 110 for memory bank 103, and register units 111, 112 for memory bank 104. Besides the memory banks there may be a lot more functional units inside the memory arrangement which also need different settings and local register units, (e.g., IO circuits, voltage generators etc).

A third example type of configuration data is configurable once for the memory arrangement 100 as a whole, but is used at several locations inside the memory arrangement 100, for example for configuring the timing characteristics of the memory banks 101-104. Therefore, this configuration data is stored nearby each of the memory banks 101-104. In the embodiment illustrated in FIG. 1 this kind of configuration data is stored in register units 113, 114, 115, and 116 for memory banks 101, 102, 103, and 104, respectively. Another example may be latency counters. There may be, for example, two latency counters, one for the left circuits near memory banks 101 and 103 and one for the right circuits near memory banks 102 and 104. They should be configured with the same time constants for proper operation of the memory arrangement. Instead of placing a central register unit and generating a lot of routing overhead to the left and right circuits, two register units are placed locally near the left and right circuits with the identical time constant content.

The register units 105-122 are connected to a configuration data bus 123 and a control unit 124 of the memory arrangement 100 controlling transmissions on the configuration data bus 123 is also connected to the configuration data bus 123. A configuration data bus 123 may comprise address lines for addressing the register units 105-122, data lines for transmitting data between the register units 105-122 and the control unit 124, and control lines, for example a read enable line and a write enable line, for controlling the data flow on the configuration data bus 123. Each register unit 105-122 comprises an address for identifying the register unit on the configuration data bus 123.

When configuration data is written from the control unit 124 to one of the register units 105-122, the control unit outputs the address of the register unit to be provided with configuration data on the address lines of the data bus 123, outputs the configuration data to be written into the addressed register unit on the data lines of the data bus 123 and asserts the write enable line of the data bus 123. Upon assertion of the write enable line, each register unit 105-122 compares the address provided on the address lines of the data bus 123 with their own address and, in the case of a match between the address on the data bus 123 and the own address, the configuration data provided on the data lines of the data bus 123 is stored in the register unit having the matching address.

When retrieving data from the register units 105-122 to the control unit 124, the control unit 124 outputs the address of the register unit of which the configuration is to be retrieved, and asserts the read enable line of the data bus 123. Upon assertion of the read enable line the register units 105-122 compare the address on the address lines of the data bus 123 with their own address and output in the case of a match between the address on the address lines of data bus 123 and the own address of the register units the configuration data on the data lines of the configuration data bus 123. Control unit 124 receives the configuration data from the data lines of the configuration data bus 123 and the read operation is completed.

As illustrated in FIG. 1, the control unit 124 is connected via a connection 125 to a memory arrangement configuration device 126. The memory arrangement configuration device 126 transmits commands and data to the control unit 124 for configuring the configuration data register units 105-122 of the memory arrangement 100 and the control unit 124 transmits or retrieves in response to the commands of the memory arrangement configuration device 126 data to and from the register units 105-122 via the configuration data bus 123. The connection 125 between the control unit 124 and the memory arrangement configuration device 126 may comprise a serial interface comprising a single line for receiving and transmitting configuration data for the memory arrangement according to a predefined protocol. Using a single wire connection as the connection 125 employs only one additional pin at the memory arrangement 100 for providing a configuration interface. Alternatively, the connection 125 may comprise any other kind of interface comprising multiple lines for configuration data communication. Using the configuration data bus 123 and arranging the register units 105-122 near the units or components of the memory arrangement 100 where the configuration data contained in the register units is used, employs very little space for connection routing inside the memory arrangement.

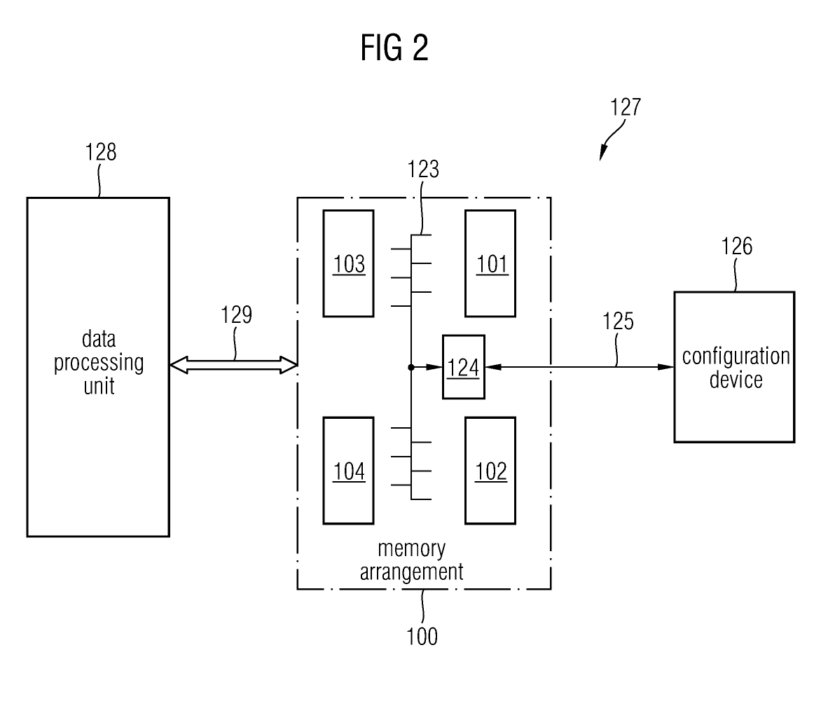

FIG. 2 illustrates one embodiment of a data processing system 127, which may be a computer system, comprising a data processing unit 128, a memory arrangement 100, and a memory arrangement configuration device 126. The data processing unit 128 is connected via a data interface 129 with the memory arrangement 100. The control unit 124 of the memory arrangement 100 controlling the configuration data bus 123 of the memory arrangement 100 is connected via a connection 125 with the memory arrangement configuration device 126.

In operation, the data processing unit 128 communicates with the memory arrangement 100 via the data interface 129 for storing data in the memory banks 101-104 of the memory arrangement 100 and for retrieving data from the memory banks 101-104 from the memory arrangement 100. The memory arrangement configuration device 126 configures the memory arrangement 100 according to the need of the data processing system 127. This configuration may comprise the setting of timing characteristics, address ranges, and communication parameters of the memory arrangement 100. As described above, this configuration data may comprise configuration data of the third type, which means configuration data that is common for the memory arrangement 100 as a whole, but is to be configured at several locations, (i.e., several register units) due to the internal structure of the memory arrangement 100. This may comprise for example the configuration of register units 113-116 of FIG. 1, wherein the same configuration data value is to be set in each register unit 113-116, as this configuration data is employed for each memory bank 101-104. By assigning the same configuration data bus address to each of the register units 113-116, the register units 113-116 can be addressed simultaneously and therefore configuration data of the third type can be set within a single transmission from the control unit 124 to the register units 113-116.

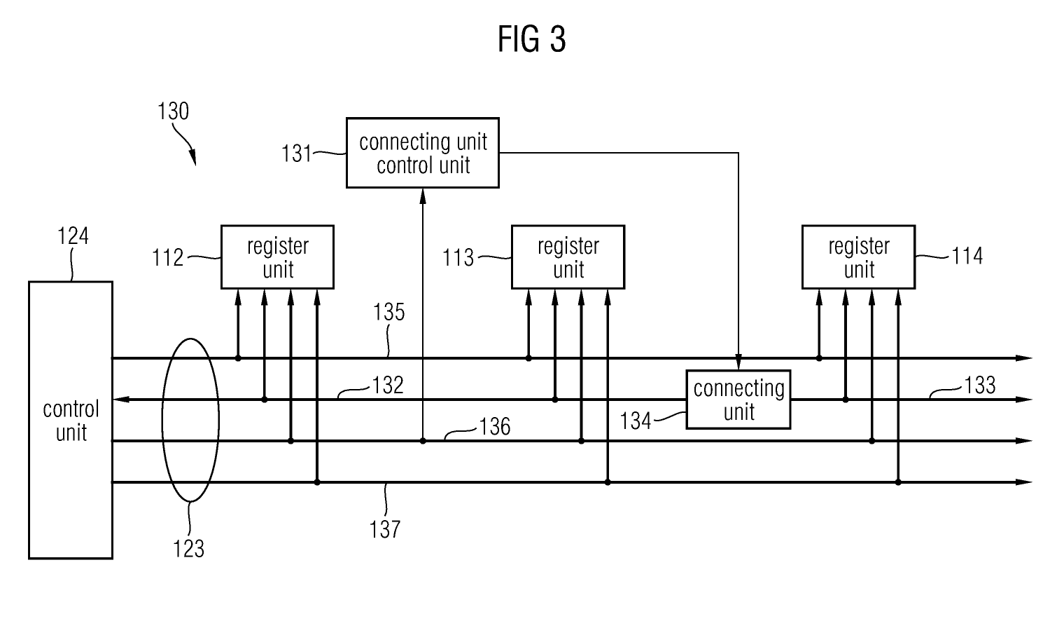

FIG. 3 illustrates details of an embodiment of a configuration data bus structure 130 providing access to two or more register units having the same address identifying the register unit on the configuration data bus. For clarity reasons, in FIG. 3 only two register units comprise the same address, but any other number of register units comprising the same address may be used, for example the four register units 113-116 of FIG. 1.

The configuration data bus structure 130 comprises a control unit 124, three register units 112-114, a configuration data bus 123, and a connecting unit control unit 131. The data bus 123 comprises a data line comprising two data line portions 132 and 133 and a data line connecting unit 134 arranged between the data line portions 132, 133. The data bus 123 comprises further address lines 135 for addressing the register units 112-114, a read enable line 136 for signaling a read operating on the configuration data bus 123, and a write enable line 137 for signaling a write operation on the data bus 123. The connecting unit 134 comprises a connecting mechanism configured to connect or disconnect the data line portions 132, 133, wherein the data line connecting unit 134 is controlled by the connecting unit control unit 131. In the embodiment illustrated in FIG. 3, when connecting unit 134 is in a state “connected”, data between control unit 124 and register unit 114 is passed through the connecting unit 134, thus providing a data exchange between the control unit 124 and the register unit 114. In state “disconnected” the connecting unit 134 prohibits a data exchange between the control unit 124 and the register unit 1 14.

Assuming that register units 113 and 114 share the same configuration data bus address, for example “address A”, for setting a configuration data value simultaneously within one write operation at both register units 113 and 114, and register unit 112 has a different address, for example “address B”, the operation of one embodiment of the configuration data bus structure 130 is as follows.

When writing configuration data from control unit 124 to address A accessing register units 113 and 114, the control unit 124 outputs address A on the address lines 135, the configuration data value to be written on the first data line portion 132, and a write enable signal on the write enable line 137. Connection unit control unit 131 is connected to the read enable line and monitors the read enable line for sending a signal to the connection unit 134 for disconnecting the connected data line portions 132, 133 in the case of a read enable signal. As there is no read enable signal on line 136, the connection control unit 131 does not detect a read enable signal and therefore connection unit 134 connects data line portion 132 to data line portion 133 passing the configuration data from the control unit 124 via the second data line portion 133 to register unit 114. Upon receiving the write enable signal each of the register units 112-114 compares the address on address lines 135 with their own address and, in the case of a match, the configuration data of the data line portions 132 and 133 are stored in the respective register units.

In this case, register units 113 and 114 detect a match between the address received on the address lines 135 and therefore the configuration data value sent from the control unit 124 is stored in each of the register units 113, 114.

In case control unit 124 addresses configuration data bus address B, the same operation takes place, except for the fact that register unit 112 stores the configuration data received via data line portion 132 instead of register units 113 and 114.

In the case of a read request to address A, the control unit 124 outputs address A on the address lines 135 and activates the read enable line 136. Upon activation of the read enable line 136 the connection unit control unit 131 controls the connection unit 134 such that connection unit 134 disconnects data line portion 132 from data line portion 133. Furthermore, upon reception of the read enable signal on read enable line 136, each of the register units 112-114 compares the address sent on the address lines 135 with their own address and outputs its configuration data value upon a match of these addresses to the data line portions it is connected to (i.e., in the present case of address A an output of configuration data of register unit 113 to data line portion 132 and an output of register unit 114 to data line portion 133). As connection unit 134 disconnects data line portions 132 and 133, only the configuration data output of register unit 113 is transmitted to the control unit 124. This can avoid glitches on the data lines due to asynchronous outputs of the register units 113 and 114 and can avoid malfunctions due to shortcuts on the data lines.

A read operation request to address B is performed in the same way as stated above, wherein in this case register unit 112 outputs the requested data to data line portion 132 and the connection state of connection unit 134 does not matter in this case.

In FIG. 3, the connection unit control unit 131 is illustrated as being connected to only the read enable line only. Nevertheless, the connection unit control unit 131 can also be connected to the address lines 135 and control the connection unit 134 depending on the address present on address lines 135. This may be useful in case, if in addition to register unit 114, some more register units (not illustrated in FIG. 3) are connected to data line portion 133 having for example address C, wherein this additional register unit is requestable by the control unit 124.

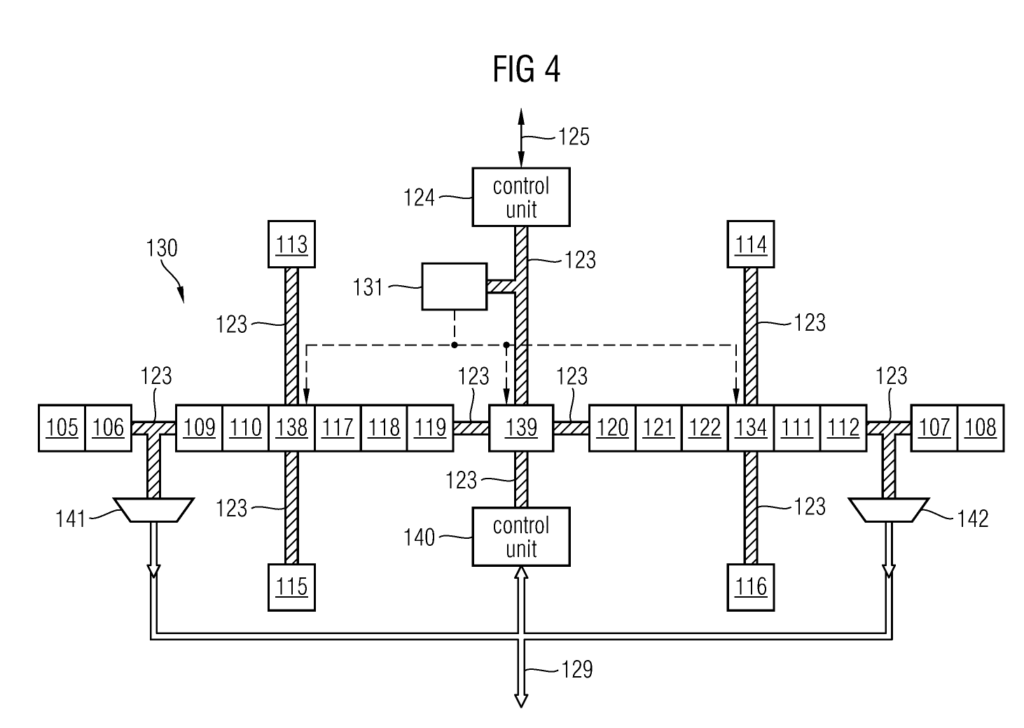

FIG. 4 illustrates one embodiment of the data bus structure 130 comprising a data bus 123 connecting a control unit 124 and register units 105-122. Furthermore, this embodiment of the data bus structure 130 comprises connection units 134, 138, and 139 adapted to connect or disconnect data line portions of the configuration data bus 123 they are connected to and controlled by a connection unit control unit 131 as described above in the description corresponding to FIG. 3. Control unit 124 can be connected via an interface 125 to a memory arrangement configuration device 126 as illustrated in FIG. 1. Register units 113-116 may have the same address for identifying the register units on the configuration data bus 123 (e.g., due to left/right and top/bottom symmetry). Doubling up register units and placing them locally may avoid routing overhead. Usually a different address is given to register units with the identical content. Often this is not possible, because (a) the address space is limited and therefore addresses have to be saved; or (b) official or standardized specifications define just a single register unit address, but physically more registers are implemented. The remaining register units 105-112 and 117-122 may have unique addresses for identifying the register units on the configuration data bus 123.

In one embodiment, assuming that register units 113-116 have address A as the address for identifying the register units on the configuration data bus, a write operation of control unit 124 addresses all four register units 113-116 at the same time. Connection units 134, 138, and 139 are controlled such that during write operation the data line portions of configuration data bus 123 are all connected to control unit 124. Therefore, a write operation to address A sets configuration data in the register units 113-116 at the same time. When requesting configuration data from address A, connection units 134, 138, and 139 are controlled in such a way that only the data line portion connected to register unit 113 is connected to the data line portion connected to the control unit 124. Thus, when requesting data from register units having address A, only configuration data of register unit 113 is forwarded to control unit 124, thus avoiding bus contentions from occurring on the data lines caused by asynchronous outputs on the same data lines from register units 113-116. As the remaining register units 105-112 and 117-122 are uniquely addressed on the configuration data bus 123, during addressing these registers, connection units 134, 138, and 139 do not disconnect data line portions of the configuration data bus 123.

Furthermore, the connection unit control unit 131 may comprise a request control register unit configurable to determine which of the register units 113-116 having the same address shall be connected through to the control unit 124 in case of a read access to these register units. With the help of such a configuration it is possible to verify the correct setting of each of the register units 113-116 during, for example, a manufacturing test of the memory arrangement.

The configuration data bus structure 130 embodiment of FIG. 4 further a second control unit 140 that can be connected via a data interface 129 to a data processing device 128 as illustrated in FIG. 2. Furthermore, two couplers 141, 142 provide a connection from the configuration data bus 123 to the data interface 129. The second control unit 140 provides via the communication via the data interface 129 a configuration data exchange which is much faster than the configuration data exchange via the interface 125 and may therefore be very useful especially during testing of the memory arrangement containing the configuration data bus structure 130 to speed up the testing time. Connecting the data interface 129 via couplers 141, 142 directly to the configuration data bus 123 may also help to speed up the configuration data exchange in case of testing a memory arrangement containing the configuration data bus structure 130.

The data interface 129 may be configured to allow a transmission of read, write, address, and command data in the form of data packets according to a predefined protocol. This data protocol may also be configured to allow a transmission of data for configuring the timing characteristics, configuration data as described above, and test data of the memory arrangement. A fast read out of these data via the couplers 141, 142 to the data interface 129 may be possible to speed up testing the memory arrangement during a manufacturing test. Furthermore, the data communication via data interface 129 and coupler 141, 142 may also be bidirectional to further increase the transmission speed of data during, for example, a manufacturing test.

FIG. 4 also illustrates the arrangement of register units 105-122 superimposed over the configuration data bus 123. In a physical realization on a chip embodiment, for example a semiconductor chip, circuits of the register units 105-122 are located on a first layer of the chip and circuits of the configuration data bus 123 are located on a second layer of the chip. The first layer and the second layer of the chip are superimposed with parts of the circuits of the configuration data bus superimposing parts of the circuits of the register units 105-122. An arrangement like this can save space on the chip, can provide short connections between the register units 105-122 and the configuration data bus 123, and can be easy to accomplish on a chip comprising several circuit layers.

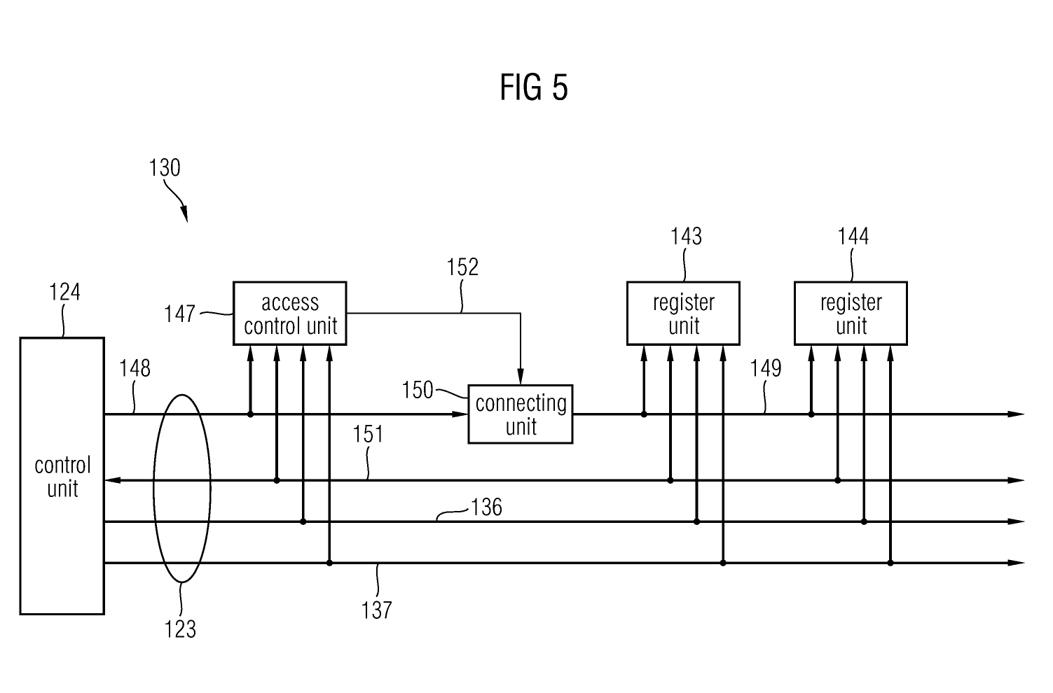

FIG. 5 illustrates one embodiment of a configuration data bus structure 130 comprising a control unit 124, register units 143 and 144, an access control unit 147 controlling the access to the register units 143, 144, and a configuration data bus 123 connecting the control unit 124, the register units 143, 144 and the access control unit 147. The configuration data bus 123 comprises two address line portions 148, 149 and an address line connecting unit 150 arranged between the address line portions 148, 149 and connecting or disconnecting the address line portions 148, 149, wherein the address line connecting unit 150 is controlled by the access control unit 147. Furthermore, the configuration data bus 123 comprises data lines 151 for transmitting configuration data between the control unit 124 and the register units 143, 144 and for transmitting access authorization data between the control unit 124 and the access control unit 147. Furthermore, the configuration data bus 123 comprises a read enable line 136 for transmitting a read enable signal and a write enable line 137 for transmitting a write enable signal as described in connection with FIG. 3.

In one embodiment, access control register 147 is accessible via the configuration data bus 123 like a regular register unit, for example register unit 112 of FIG. 3, as described above. When a certain predetermined value is written into access control register 147, access control register 147 controls via control line 152 the address line connecting unit 150 such that the address line connecting unit 150 passes all addressing information from address line portion 148 to address line portion 149 transparently through. In this situation an access to a register unit 143, 144 from the control unit 124 is possible as described above in the description corresponding to FIG. 3. On any other value written into access control unit 147, access control unit 147 outputs a control signal via control line 152 to the address line connecting unit 150 such that all addressing information coming from control unit 124 via address line portion 148 is blocked by address line connecting unit 150 and therefore register units 143 and 144 cannot be accessed by control unit 124 anymore. “Blocking” in this context means that the address information is not forwarded to address line portion 149, for example in that at least one of the address lines is kept fixed to a certain value such that none of the register units connected to address line portion 149 can be addressed anymore.

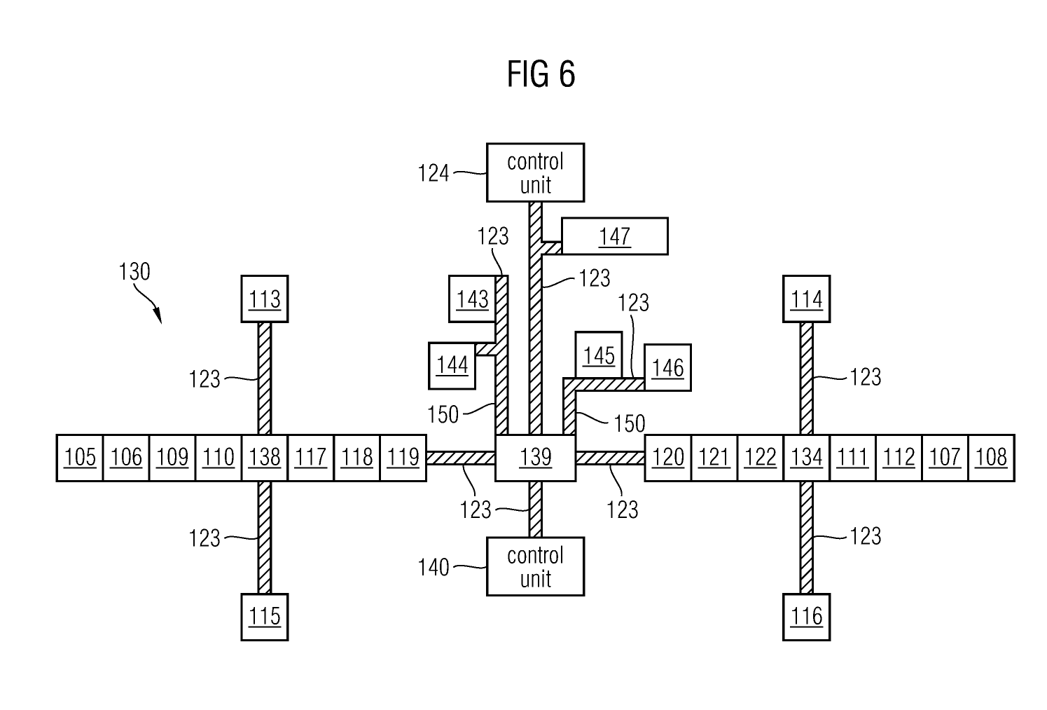

In one embodiment, an access mechanism like this provides for a manufacturer of a semiconductor memory chip the possibility to realize an arbitrary number of register units for test and configuration purposes that can be hidden and made unaccessible to the end customer, and allows these register units to be accessible only to those that know the certain predetermined value that has to be written into the access control unit 147 for accessing these hidden register units. Additionally, this provides an easy and inexpensive way of realizing such hidden register units, when a configuration data bus structure, such as illustrated in FIG. 3 or 4 is already present in the memory arrangement. Furthermore, the mechanism embodiment illustrated in FIG. 5 for protecting hidden register units 143, 144 from an access by unauthorized users, may be combined with a configuration data bus structure, such as illustrated in FIGS. 3 and 4 as illustrated in FIG. 6.

FIG. 6 illustrates one embodiment of a configuration data bus structure 130 comprising a first and a second control unit 124, 140, register units 105-122, data line connecting units 134, 138 and 139, and a data bus 123 connecting the control units, register units, and data line connecting units as illustrated in FIG. 3. Furthermore, the configuration data bus structure 130 embodiment of FIG. 6 comprises an access control unit 147 connected to the configuration data bus 123 and register units 143-146 connected to the configuration data bus 123, wherein address line connecting units 150 are allowed to connect or disconnect (block or unblock) the address lines of the configuration data bus for accessing register units 143-146 as described in the description corresponding to FIG. 5. Depending on the particular register unit address, not only the access to register units 143-146 can be blocked, but also the access to register units 105-122 can be blocked, if they are located in the protected address space.

In one embodiment, after a reset of the memory arrangement containing the configuration data bus structure 130 the access control register unit 147 is set to a default value providing no access to the register units 143-146. Thus, it is assured that after a cold start or a reset of the memory arrangement, an access to the hidden register units 143-146 is denied.

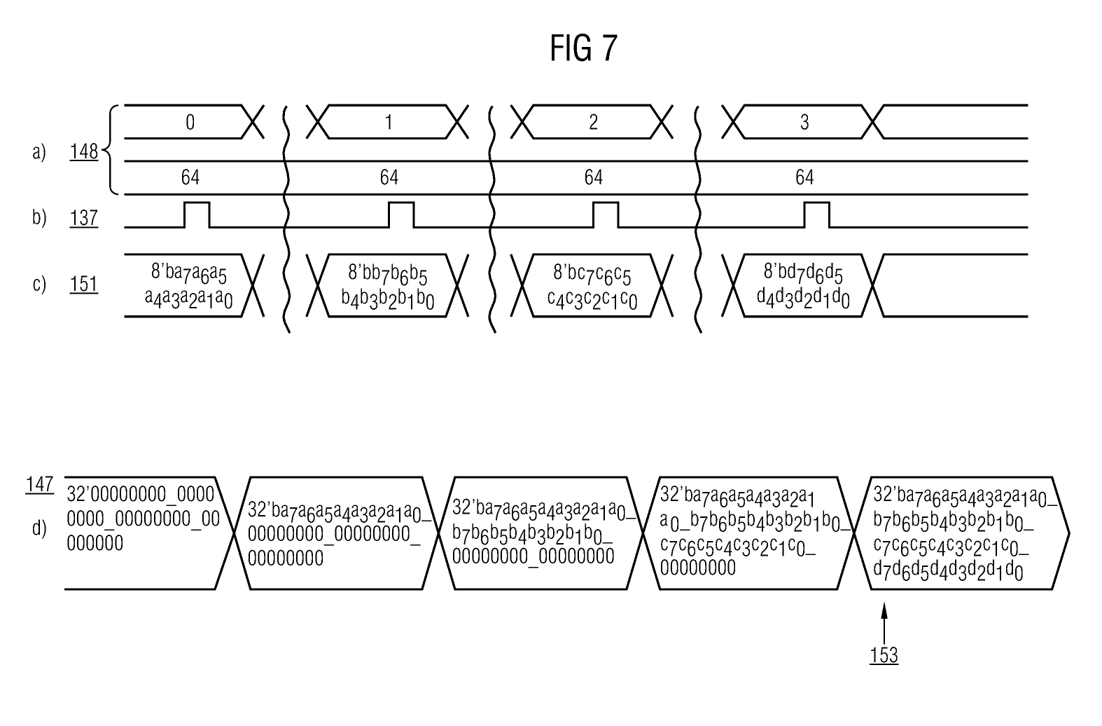

The access control register unit 147 may comprise a 32-bit word which is set to a predetermined value to grant access to the register units 143-146. If the configuration data bus structure 130 provides for example an 8-bit data bus, the 32-bit value has to be set in four separate write operations as illustrated in FIG. 7.

FIG. 7 illustrates one embodiment of a data flow on a configuration data bus structure, which illustrates how to set this 32-bit value into the access control register unit 147 by way of four write accesses using the same address 64 and additionally using a byte select signal of the configuration data bus identifying the bytes 0-3 of the access control register unit 147. FIG. 7a illustrates the signaling of the address lines and the byte select lines, wherein the address lines have the value 64 and the byte select signal subsequently provides the values 0, 1, 2, and 3 accordingly to this embodiment. FIG. 7b illustrates the write enable signal enabling for each byte select value once the writing of the configuration data transmitted on the data lines as illustrated in FIG. 7c accordingly to this embodiment. FIG. 7c illustrates accordingly to this embodiment the configuration data signal containing for each write cycle the appropriate data, (e.g., a₀-a₇ in the first cycle for byte select 0 to d₀-d₇ in the fourth write cycle for byte select 3). FIG. 7d illustrates accordingly to this embodiment the value of the access control register unit 147 changing with each write cycle from all 0 to the value written within the four write cycles as illustrated in FIGS. 7a-7c. If after the fourth write cycle the value of access control register unit 147 corresponds to the predetermined value for granting the access to register units 143-146 from the point of time indicated by arrow 153 of FIG. 7d an access to register units 143-146 is granted. Although the access control register unit 147 described above comprises a 32 bit word which is written in cycles using different byte select signals, the access control register unit 147 may comprise any other size (e.g., 8, 16, 64 or 128 bits) and may be addressed in any other way as appropriate.

As described above, the embodiments described above with reference to the figures may be each realized in a dedicated chip or any combination of the embodiments described above may be realized within one chip combining the functionality and characteristics of these embodiments. Furthermore, the embodiments described above may not only be used in a memory arrangement, but may also be used in other arrangements containing configuration data (e.g., in I/O devices of data processing systems).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method of transmitting configuration data in a memory arrangement, the method comprising:
controlling, with a control unit of the memory arrangement, data transmissions via a configuration data bus in the memory arrangement, the controlling including controlling transmitting configuration data of the memory arrangement for storing in at least two register units of the memory arrangement via the configuration data bus from the control unit to each of the at least two register units;
storing, in the at least two register units, the configuration data, wherein the at least two register units have a same bus address identifying the at least two register units on the configuration data bus;
requesting, with the control unit, configuration data stored in the at least two register units; and
transmitting, under control of the control unit, the stored configuration data via the configuration data bus from only one of the at least two register units to the control unit.

2. The method of claim 1, comprising:
determining, via a content of a request control register unit of the memory arrangement, from which of the at least two register units the requested configuration data is transmitted to the control unit in response to requesting configuration data.

3. The method of claim 1, wherein two control units controlling data transmissions via the configuration data bus are connected to the configuration data bus.

4. The method of claim 1, wherein a further register unit is connected to the configuration data bus, the further register unit having a unique bus address identifying the further register unit on the configuration data bus, wherein the method comprises:
storing configuration data in the further register unit including transmitting, via the configuration data bus, the configuration data from the control unit to the further register unit;
requesting, with the control unit, configuration data stored in the further register unit; and
transmitting, under control of the control unit, the stored configuration data from the further register unit, via the configuration data bus, to the control unit.

5. A method of transmitting configuration data in a memory arrangement, the method comprising:
controlling, with a control unit of the memory arrangement, data transmissions via a configuration data bus in the memory arrangement, the controlling including controlling transmitting configuration data for storing in a register unit of the memory arrangement; and
controlling, with an access control unit of the memory arrangement, an access to the register unit via the configuration data bus, the controlling of the access including controlling storing configuration data from the control unit in the register unit and controlling requesting configuration data by the control unit from the register unit, such that the register unit can be accessed only if a predetermined information is set in the access control unit.

6. The method of claim 5, wherein two control units for controlling data transmissions via the configuration data bus are connected to the configuration data bus.

7. The method of claim 5, wherein a further register unit is connected to the configuration data bus, wherein, when storing configuration data from the control unit in the further register unit or requesting configuration data by the control unit from the further register unit, the further register unit can be accessed irrespective of the information set in the access control unit.

8. A memory arrangement, comprising:
a configuration data bus structure configured to transmit configuration data of the memory arrangement and comprising a data line comprising data line portions and data line connecting units arranged between the data line portions and connecting or disconnecting the data line portions;
a connecting unit control unit configured to control the data line connecting units;
a control unit configured to control data transmissions via the configuration data bus structure and connected via a first interface to the configuration data bus structure and to be connected via a second interface to a memory arrangement configuration device located outside of the memory arrangement, wherein the control unit is configured to transmit and request configuration data to and from the configuration data bus structure in response to commands received via the second interface; and
at least two register units connected to the configuration data bus structure and configured to store configuration data of the memory arrangement, wherein the at least two register units have a same bus address identifying the at least two register units on the configuration data bus structure;
wherein the control unit and the at least two register units are connected to the data line portions and the connecting unit control unit controls the data line connecting units such that, when the control unit transmits configuration data to the at least two register units, the data line portions and the data line connecting units connect the control unit to each of the at least two register units, and, when the control unit requests configuration data from the at least two register units, the data line connecting units and the data line portions connect the control unit to only one of the at least two register units.

9. The memory arrangement of claim 8, comprising:
a second control unit connected to the configuration data bus.

10. The memory arrangement of claim 8, wherein the connecting unit control unit comprises a request control register unit, wherein a content of the request control register unit is used by the connecting unit control unit to determine from which of the at least two register units the requested configuration data is to be transmitted to the control unit in the case of requesting configuration data by the control unit.

11. The memory arrangement of claim 8, comprising:
a further register unit connected to the configuration data bus, the further register unit having a unique bus address identifying the further register unit on the configuration data bus;
wherein the plurality of data line portions, the data line connecting units, the control unit, and the further register unit are arranged and the connecting unit control unit controls the data line connecting units such that, when the control unit stores data in the further register unit, the data line portions and the data line connecting units connect the control unit to the further register unit, and, when the control unit requests data from the further register unit, the data line connecting units and the data line portions connect the control unit to the furt her register unit.

12. The memory arrangement of claim 8, wherein the second interface of the control unit comprises a serial interface configured to connect the control unit to the memory arrangement configuration device.

13. The memory arrangement of claim 12, wherein the serial interface comprises a single line only for receiving and transmitting configuration data for the memory arrangement according to a predefined protocol.

14. The memory arrangement of claim 8, wherein the memory arrangement comprises:
a data interface configured to transmit command, address, read and write data between the memory arrangement and a data processing device to be connected to the memory arrangement; and
a further control unit configured to control data transmissions via the configuration data bus structure and connected via a first interface of the further control unit to the configuration data bus structure and to be connected via a second interface of the further control unit to a memory arrangement configuration device located outside of the memory arrangement;
wherein the second interface of the further control unit comprises the data interface of the memory arrangement.

15. The memory arrangement of claim 8, wherein the configuration data bus structure and the at least two register units are located on a single chip;
wherein a circuit of the at least two register units is located on a first layer of the chip and a circuit of the configuration data bus structure is located on a second layer of the chip; and
wherein the first layer and the second layer of the chip are superimposed with parts of the circuit of the configuration data bus structure superimposing parts of the circuit of the at least two register units.

16. The memory arrangement of claim 8, wherein the memory arrangement is implemented on a single chip.

17. A memory arrangement comprising:
a configuration data bus structure configured to transmit configuration data of the memory arrangement and comprising an address line comprising address line portions and address line connecting units arranged between the address line portions and connecting or disconnecting the address line portions;
a control unit configured to control data transmissions via the configuration data bus structure and connected via a first interface to the configuration data bus structure and to be connected via a second interface to a memory arrangement configuration device located outside of the memory arrangement, wherein the control unit is configured to transmit and requests configuration data to and from the configuration data bus structure in response to commands received via the second interface;
a register unit connected to the configuration data bus structure and configured to store configuration data of the memory arrangement; and
an access control unit connected to the configuration data bus structure and configured to control the access to the register unit and the address line connecting units;
wherein the control unit and the access control unit are connected to a same address line portion of the address line portions and the register unit is connected to another of the address line portions;
wherein the address line portions, the address line connecting units, the control unit and the register unit are arranged and the access control unit controls the address line connecting units such that, when the control unit transmits configuration data to the register unit or requests configuration data from the register unit, the address line portion connected to the register unit is connected to the address line portion connected to the control unit only if a predetermined information is set in the access control unit.

18. The memory arrangement of claim 17, wherein the second interface of the control unit comprises a serial interface configured to connect the control unit to the memory arrangement configuration device.

19. The memory arrangement of claim 21, wherein the serial interface comprises a single line only for receiving and transmitting configuration data for the memory arrangement according to a predefined protocol.

20. The memory arrangement of claim 21, wherein the memory arrangement comprises
a data interface configured to transmit command, address, read and write data between the memory arrangement and a data processing device to be connected to the memory arrangement; and
a further control unit configured to control data transmissions via the configuration data bus structure and connected via a first interface of the further control unit to the configuration data bus structure and via a second interface of the further control unit to a memory arrangement configuration device located outside of the memory arrangement;
wherein the second interface of the further control unit comprises the data interface of the memory arrangement.

21. The memory arrangement of claim 17, comprising:
a further register unit of the memory arrangement is connected to the configuration data bus, wherein the plurality of address line portions, the address line connecting units, the control unit and the further register unit are arranged and the access control unit controls the address line connecting units such that, when the control unit stores configuration data in the further register unit or requests configuration data from the further register unit, the address line portions and the address line connecting units connect the control unit to the further register unit.

22. A computer system comprising:
a data processing unit;
a memory arrangement connected to the data processing unit via a data interface, and
a memory arrangement configuration device for configuring the memory arrangement and connected to the memory arrangement;
wherein the memory arrangement comprises:
a configuration data bus structure configured to transmit configuration data of the memory arrangement and comprising a data line comprising data line portions and data line connecting units arranged between the data line portions and connecting or disconnecting the data line portions;
a connecting unit control unit configured to control the data line connecting units;
a control unit configured to control data transmissions via the configuration data bus structure and connected via a first interface to the configuration data bus structure and to be connected via a second interface to a memory arrangement configuration device located outside of the memory arrangement, wherein the control unit is configured to transmit and request configuration data to and from the configuration data bus structure in response to commands received via the second interface; and
at least two register units connected to the configuration data bus structure and configured to store configuration data of the memory arrangement, wherein the at least two register units have a same bus address identifying the at least two register units on the configuration data bus structure;
wherein the control unit and the at least two register units are connected to the data line portions and the connecting unit control unit controls the data line connecting units such that, when the control unit transmits configuration data to the at least two register units, the data line portions and the data line connecting units connect the control unit to each of the at least two register units, and, when the control unit requests configuration data from the at least two register units, the data line connecting units and the data line portions connect the control unit to only one of the at least two register units.

23. The computer system of claim 22, wherein the data interface is configured to allow a transmission of read, write, address, and command data in the form of data packets according to a predefined protocol.

24. The computer system of claim 22, wherein the second interface is configured to allow a transmission of configuration and test data configuring and testing the memory arrangement.

25. The computer system of claim 24, wherein the configuration data comprises data for configuring the timing characteristics of the memory arrangement.
